(19) United States
(12) Patent Application Publication
(10) Pub. No.: US 2022/0327261 A1
(43) Pub. Date: Oct. 13, 2022

(54) COMPUTER-IMPLEMENTED METHOD FOR CREATING A NETWORK FOR SIMULATING AN OBJECT

(71) Applicant: Volume Graphics GmbH, Heidelberg (DE)

(72) Inventor: Karl-Michael NIGGE, Heidelberg (DE)

(21) Appl. No.: 17/640,739

(22) PCT Filed: Aug. 26, 2020
(86) PCT No.: PCT/EP2020/073899

§ 371 Date: Mar. 4, 2022

(30) Foreign Application Priority Data
Sep. 5, 2019 (DE) 10 2019 123 826.9

(51) Int. Cl. G06F 30/23

(52) U.S. Cl. CPC G06F 30/23

(57) ABSTRACT

Described is a method for creating a network for simulating an object, wherein the network is determined by means of object data of the object, that is used to provide a digital representation of the object that has a plurality of spatially resolved structural information relating to the object. The method may comprise: providing object data of the object; carrying out a first simulation of at least one spatially resolved physical variable of the object by means of the object data; determining spatially resolved structural information to be taken into consideration by means of the simulated spatially resolved physical variable of the object for a network for simulating the object from the plurality of spatially resolved structural information; and creating the network by means of the structural information for a second simulation of the object. A computer-implemented method may reduce the number of elements of the network for the simulation.

The invention relates to a computer-implemented method for creating a mesh for simulating an object.

Many simulation methods for simulating the physical properties of an object require the creation of a mesh that is adapted to the simulation. For example, if a finite-element analysis is to be performed, for example, a numerical simulation of the mechanical properties of a geometry measured using computer tomography techniques, a suitable mesh must be created that simulates the geometry of the object to be simulated. Based on this mesh, which comprises elements that can consist of many small shape primitives, e.g. tetrahedra, which can be connected to their direct neighbors via a common surface, the simulation of the relevant, possibly local, properties can then be carried out. In particular in the environment of small defects, e.g. pores, inside the geometry of the object to be simulated, or at surfaces/interfaces with large curvatures or small radii of curvature, the size of the elements of the mesh must be selected in such a way that the effects to be simulated can be realistically reproduced. If these structures are not modeled correctly in the mesh, the effects to be simulated may not be reproduced with the required accuracy. This is particularly relevant for so-called stress peaks, as these are locations where cracks can often form which can propagate and lead to damage or the destruction of the object. These positions are arranged in small regions of greatly increased stress, such as can occur at indentations. Small changes in the simulated geometry have a large impact on the simulation result in the presence of stress peaks. Therefore, at these points it is particularly important to model the geometry of the object as accurately as possible. This also applies to pores, as not only the size but also the shape, in particular, is extremely pertinent to the simulation result. However, a large number of elements in the mesh results in long computing times during the simulation itself. The computing time of the simulation can be so long that the simulation cannot be performed within a practical period of time.

The object of the invention is therefore to provide a computer-implemented method that reduces the number of elements of the mesh for the simulation.

The main features of the invention are specified in claims 1 and 15. Embodiments of the invention are the subject matter of claims 2 to 14.

The invention provides a computer-implemented method for creating a mesh for simulating an object, wherein the mesh is determined by means of object data of the object, wherein a digital representation of the object is provided by the object data, wherein the digital representation of the object has a plurality of spatially resolved structural information relating to the object, and wherein the method comprises the following steps: providing object data of the object; carrying out a first simulation of at least one spatially resolved physical quantity of the object by means of the object data; identifying spatially resolved structural information to be taken into account by means of the simulated spatially resolved physical quantity of the object for a mesh for simulating the object from the plurality of spatially resolved structural information; and creating the mesh for simulating the object by means of the structural information to be taken into account for a second simulation of the object.

With the invention, a first simulation is therefore carried out before converting the object data of an object to be simulated into a mesh. Based on the results of the first simulation, it is estimated whether a local simplification of the underlying geometries of the object is possible to reduce the number of elements of the mesh. By taking only certain spatially resolved structural information from the object data into account for creating the mesh required for the second simulation, a simplification is achieved. For example, only certain structural information, such as defects or geometries in the object relevant to stability, is taken into account when creating the mesh for the second simulation. In the regions of the object data that contain spatially resolved structural information to be taken into account, the mesh created maps the object data with a higher accuracy than in those regions that do not contain any spatially resolved structural information to be taken into account. The result of the first simulation is used to derive the decision as to whether spatially resolved structural information in a given region must be taken into account in the mesh. Based on the results of the first simulation, a mesh optimized for the second simulation is thus provided for this second simulation. The first simulation can then require less computing time than the second simulation for which the mesh is determined. It also reduces the time required to create the mesh for the second simulation. Due to the optimized mesh, the time for the creation of the mesh and/or the computing time for the second simulation can be optimized, i.e. reduced, since the mesh has a high resolution only in the regions of the object with the spatially resolved structural information to be taken into account, and therefore a large number of arithmetic operations only needs to be performed in these regions. Outside of these regions, only a small number of computing operations is required, as the resolution outside of these regions is lower than within these regions due to the spatially resolved structural information being disregarded. The combined time for creating the mesh, the computing time of the first simulation and the second simulation, can be less than the sum of a time taken to create the mesh and a computing time of the second simulation, which without a prior first simulation would take into account all spatially resolved structural information. Without a prior first simulation, the time taken to create the mesh could become particularly large due to a large number of details to take into account. In some cases, it is only by performing the first simulation with the creation of the mesh used for the second simulation that makes the second simulation practical at all. A computer-implemented method is therefore provided that reduces the number of elements in the mesh for the second simulation. The accuracy of the second simulation is only slightly reduced compared to conventional methods.

The mesh can also be called a geometry-conformant mesh or a geometry-conformant mesh representation of the object.

The object data of the object can comprise the geometry of the object. This means that the object data contains structural information about external and internal surfaces or boundary surfaces of the object. These boundary surfaces can also delimit defects, such as pores, cracks, structural discontinuities and/or inclusions from the rest of the material of the object. Defects can be small geometries or regions of large curvature in the object, which only need to be represented with a comparatively large number of elements in a mesh in order to obtain accurate simulation results. In this way, the object data provides a digital object representation of the object. Spatially resolved structural information can be understood to mean both internal and external boundary surfaces, as well as properties within the object material, such as its density. In an example, the spatially resolved structural information may be available in the form of image information in the object data.

According to the computer-implemented method, the object data of the object is first provided. A first simulation is then performed using the object data provided. The first simulation simulates at least one spatially resolved physical quantity of the object using the object data. In one example, relative to the second simulation the first simulation can simulate the object only relatively coarsely, i.e. with a low resolution, for example. The simulated spatially resolved physical quantity of the object is used to identify spatially resolved structural information to be taken into account from the object data. The simulated spatially resolved physical quantity can provide additional information about the spatially resolved structural information to evaluate which spatially resolved structural information might be relevant, for example, to the stability or function of the object. In the regions where simulation results relevant to the object's function are encountered, more accurate simulation of the geometry tends to be required. These are usually those regions where extreme, usually maximum, simulation results occur. This means that of the total number of the plurality of spatially resolved structural information items, only the relevant spatially resolved structural information that is relevant to the second simulation is identified. Only this spatially resolved structural information will then be taken into account as the spatially resolved structural information to be considered when creating the mesh for the second simulation.

In an example, the method additionally comprises the following step: providing the mesh for simulating the object to perform the second simulation of the object.

According to an example, the mesh for simulating the object using the spatially resolved structural information to be considered can be created by means of the object data. This means that the object data that was used by the first simulation will also be used by the second simulation.

In an alternative example, the mesh for simulating the object using the structural information to be considered can be created using other object data. In this example, the second simulation uses different object data than the first simulation. For example, the first simulation can use a CAD model of the object and thus the nominal geometry, while the second simulation can use measurement data from a computer tomography measurement. Defects can be represented with a computer tomography measurement with sufficient accuracy for the simulations.

In one example, the second simulation can simulate the at least one spatially resolved physical quantity or other spatially resolved physical quantities already used in the first simulation. In other words, the first simulation and the second simulation can simulate the same spatially resolved physical quantity or different spatially resolved physical quantities.

Furthermore, the first simulation and/or the second simulation can be a mechanical simulation of the object.

In one example, the spatially resolved physical quantity is a local equivalent stress of the object.

The local equivalent stress can be a von Mises equivalent stress. However, depending on the material class and the type of loading on the object, alternative or additional equivalent stresses can also be used. For example, the material class can be defined as ideally tough, ductile, or ideally brittle. The load type can be, for example, a static, vibrational, or impact load. In the regions where a high or the largest or largest local equivalent stress is detected, the signs of mechanical failure of the material may appear first. This means that the first simulation can be used to estimate the regions in the object in which spatially resolved structural information should be taken into account. In these regions in the object or the object data, the created mesh can reproduce the object data or the geometries of the object with high accuracy. Outside of these areas, a comparatively inaccurate reproduction of the object data using the created mesh is sufficient.

In another example, the step of identifying spatially resolved structural information to be taken into account for a mesh for simulating the object from the plurality of structural information by means of the simulated spatially resolved physical quantity of the object comprises the following sub-steps: determining a local threshold value for a relevance measure of a spatially resolved structural information item from the simulated spatially resolved physical quantity of the object and providing at least part of the spatially resolved structural information of the plurality of spatially resolved structural information as spatially resolved structural information to be taken into account when a relevance measure of a spatially resolved structural information item exceeds the determined threshold value.

A relevance measure can be determined for each item of simulated spatially resolved structural information. The relevance measure can contain information about the extent of a spatially resolved structural information item. The relevance measure which is compared with the local threshold value can be used to determine qualitatively whether an item of spatially resolved structural information must be taken into account. The local threshold value for the relevance measure is determined from the simulated spatially resolved physical quantity after the first simulation. For example, a spatially resolved graph of the simulated spatially resolved physical quantity can be used to determine the local threshold. For each item of spatially resolved structural information, e.g. in the event of defects, it can be decided not to take this spatially resolved structural information into account in the mesh. The region that contains this spatially resolved structural information can then be treated in the same way as the surrounding material. Alternatively, it could also be decided to take the defect or a small structure on the surface into account in the mesh, but only with low resolution. The elements of the mesh in these regions then tend to have a larger average size than the regions with the spatially resolved structural information that is taken into account with high resolution in the mesh. This saves additional computing time in the second simulation.

According to another example, the spatially resolved structural information may contain defect information within the digital representation of the object.

Defect information is understood to include, in particular, geometric information about defects of the object. Defect information within the digital representation of the object can include information on, for example, boundary surfaces of pores, cracks, structural discontinuities, and inclusions, and if applicable, further information about defects in the digital representation of the object. The defect information can therefore also contain information about pores in the digital representation of the object. Information is assigned to positions within the digital representation of the object if the corresponding position is bounded by an outer surface of the object.

In another example, the step of identifying spatially resolved structural information to be taken into account for a mesh for simulating the object from the plurality of spatially resolved structural information by means of the simulated spatially resolved physical quantity of the object can comprise the following sub-steps: defining a range of values for the spatially resolved physical quantity; identifying at least one region in the object data to which the at least one spatially resolved physical quantity of the object is assigned within the range of values; and providing defect information as spatially resolved structural information from the at least one region to be taken into account.

Thus, defects in the mesh are only taken into account in regions of the representation of the object in which the result of the spatially resolved physical quantity determined with the first simulation lies within a specified range of values. Optionally, no defect information outside of the at least one region is provided or considered.

In another example, the step of identifying spatially resolved structural information to be taken into account for a mesh for simulating the object from the plurality of spatially resolved structural information by means of the simulated spatially resolved physical quantity of the object can comprise at least one of the following sub-steps: identifying an orientation of defects described by the defect information with respect to a direction of a simulated load and/or a shape of defects described by the defect information; and providing the defect information as spatially resolved structural information to be taken into account on the basis of the identified orientation and/or shape.

Thus, the shape and orientation of a defect can also be taken into account in the spatially resolved structural information. For example, if a plate-shaped defect is oriented perpendicular to the loading direction, this tends to be more problematic than if a cigar-shaped defect is oriented parallel to this direction. The latter case can tend to be neglected when creating the mesh. This allows the computing time of the second simulation to be further optimized.

In addition, the step of creating the mesh for simulating the object by means of the structural information to be taken into account for a second simulation of the object can comprise the following sub-step: creating the mesh for simulating the object on the object data.

The first simulation is thus advantageously performed with the object data which is also to be examined in the second simulation.

In another example, the first simulation is designed to use a non-geometry-conformant mesh on at least a portion of the object data.

This can mean, for example, that for the first simulation, the geometry-conformant mesh representations of the object can be at least partially excluded. The first simulation can therefore be carried out using a method that allows the use of a non-geometry-conformant mesh. For the range of the object data used with the non-geometry-conformant mesh, for example, a trivial, i.e. regular and non-geometry-conformant, lattice can be used for the first simulation. In these regions, the first simulation can use integration points that are set only in the material of the object to take into account the geometry of the object. It is preferable for the first simulation to be performed entirely with a non-geometry-conformant mesh representation. The first simulation can associate a regular lattice, for example, to the object data in regions where a non-geometry-conformant mesh is used, and simulate the spatially resolved physical quantity only on or around the corresponding lattice points. This allows the plurality of the potentially relevant defects or small-scale, spatially resolved structural information in general, to be captured without the need to create a geometry-conformant mesh of the object data beforehand.

The object data can also comprise, for example, measurement data of a computer tomography measurement of the object.

The measurement data can contain information about the geometry of the object, in particular about the internal and external boundary surfaces of an object. In addition, the measurement data can also provide information about the local material properties of the object such as density, porosity, fiber density, and fiber orientation.

In another example, the at least one spatially resolved physical quantity can comprise spatially resolved mechanical stress values, wherein the step of identifying spatially resolved structural information to be taken into account for a mesh for simulating the object from the plurality of spatially resolved structural information using the simulated spatially resolved physical quantity of the object comprises the following sub-steps: identifying spatially resolved mechanical stress values that are local maxima; and providing defect information as spatially resolved structural information to be taken into account from a region of the object data that has a predefined extension around the identified spatially resolved mechanical stress values.

In objects, in particular in small structures, the spatially resolved mechanical stress values may contain local maxima at which the material can fail. These positions of localized stress values which are local maxima can be caused, for example, by notch-shaped structures, in particular defects. Positions of localized mechanical stress values that are local maxima can be stress peaks. The region of predefined extension extends around the local maxima of the spatially resolved mechanical stress value. Even if a stress peak has a very small spatial extension, the range of pre-defined extension around the stress peak is used to provide defect information as spatially resolved structural information from this region to be considered. A lower threshold value can be defined, which the spatially resolved mechanical stress values that are local maxima must exceed in order for the sub-step to be performed that provides defect information as spatially resolved structural information to be taken into account from a predefined range of the object data that contains the identified spatially resolved mechanical stress values. This means that spatially resolved structural information from regions which have stress values that are critical to the object's function or stability and that could have caused stress peaks can be taken into account during the creation step. This improves the quality of the second simulation, in particular for the correct simulation of the stress peaks.

In another example, the spatially resolved structural information is assigned to different materials, wherein in the step of identifying spatially resolved structural information to be taken into account for a mesh for simulating the object from the plurality of spatially resolved structural information by means of the simulated spatially resolved physical quantity of the object, a material-specific rule for taking into account spatially resolved structural information is used for each material.

The information about the surrounding material can be taken into account in the decision. This is particularly relevant for objects that comprise multi-materials, i.e. boundary surfaces within the object that have material or structural differences. For example, stresses of a certain order of magnitude which are completely unproblematic for steel can already be problematic for plastics.

According to an example, at least a portion of the spatially resolved structural information, which is not taken into account in the step of identifying spatially resolved structural information to be taken into account for a mesh for simulating the object from the plurality of spatially resolved structural information by means of the simulated spatially resolved physical quantity of the object, can be provided to the second simulation as a material property of the object at a position of the spatially resolved structural information that is not taken into account.

A pore in the object could be roughly approximated in the object data by, for example, reducing the strength of the material as a material property in the corresponding element or the corresponding elements of the mesh in proportion to the volume of the pore. An average value for the material property can also be used. The underlying rules for deciding that spatially resolved structural information will be taken into account in the mesh or in the material properties do not need to be identical. Accordingly, there may also be more than two cases, for example three, which are evaluated sequentially. It is possible to decide first whether a spatially resolved structural information item in a first case is not taken into account in the mesh or in the material properties. It can then be decided whether the spatially resolved structural information is taken into account only in the material properties or only in the mesh.

In a further example, the first simulation can be used as a basis for estimating whether it is still necessary to perform a second simulation. If it is already possible to conclude from the first simulation that a second simulation is not necessary, the second simulation, including the meshing of the geometry, can be omitted, and thus computing time can be saved. A possible reason for this is that the required result was already able to be determined with sufficient accuracy during the first simulation.

A further aspect of the invention relates to a computer program product having instructions executable on a computer, which when executed on a computer cause the computer to carry out the method as claimed in the preceding description.

Advantages and effects as well as further developments of the computer program product arise from the advantages and effects as well as the further developments of the above described method. In this respect, reference is therefore made to the preceding description. For example, a computer program product can mean a data carrier on which a computer program element is stored, that contains instructions that can be executed for a computer. Alternatively, or in addition, a computer program product can also mean, for example, a permanent or volatile data store, such as flash memory or RAM, that contains the computer program element. However, other types of data stores that contain the computer program element are not excluded.

Further features, details and advantages of the invention result from the wording of the claims, as well as from the following description of embodiments on the basis of the drawings. In the drawings:

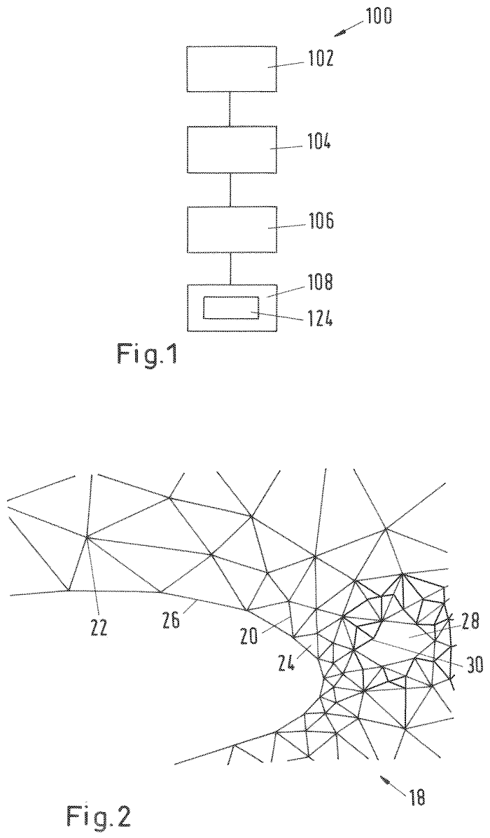

FIG. 1 shows a flowchart of the method;

FIG. 2 shows a schematic representation of a mesh for simulating an object;

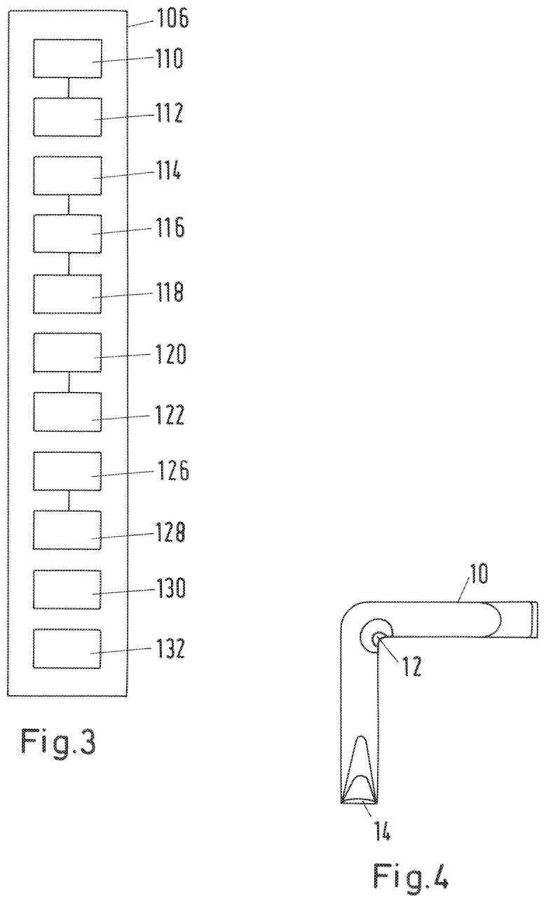

FIG. 3 shows a flowchart with optional sub-steps of the identifying step; and

FIG. 4 shows a schematic representation of a visualized first simulation of a physical quantity.

The following explains in more detail, by reference to FIG. 1, the computer-implemented method 100 for creating a mesh for simulating an object.

The mesh is determined in this case by means of object data of the object. That is, the object data is used to create the mesh. The mesh can be created on the object data used in the determination of the mesh or on other object data. Object data provides a digital representation of the object, i.e. the object can be represented digitally by means of the object data. The digital representation of the object contains a plurality of spatially resolved structural information about the object. The structural information may be available, for example, as image information, which is formed by voxels or pixels. Alternatively, the structural information can also be available as a surface data set, e.g. in STL format, or as an implicit representation, e.g. as a distance field.

In a first step 102, the object data of the object is provided. The object data can be, for example, measurement data of a computer tomography measurement. The measurement data of a computer tomography measurement comprises a representation of the geometry of the object, which in comparison to other measurement methods describes precise information about the internal and external boundary surfaces of the object.

The object data can also be obtained using other volumetric measurement methods.

Here, geometry information can be measurement data obtained from an ultrasonic measurement or a measurement from a magnetic resonance tomograph, for example. Other measurement methods, such as structured light projection or photogrammetry, can also be used to obtain object data and thus geometry information about the object.

The object data can also be obtained from a simulation of a manufacturing process, for example from a simulation of an injection molding, metal casting or additive manufacturing process, including the simulation of defects in the simulated object. In the same way, the object data can be obtained from monitoring a manufacturing process, for example, from process data that is determined during an additive manufacturing of an object. Furthermore, the object data can be obtained from a nominal geometry of an object, for example a CAD model.

If the object data is measurement data, the measurement data can be used immediately after it has been acquired. Alternatively, the object data can be loaded from a data store.

In a second step 104, a first simulation of the object is performed using the object data. At least one spatially resolved physical quantity of the object is simulated.

For example, the at least one spatially resolved physical quantity can be a local equivalent stress in the object. This can be a stress distribution in the object, for example. The local equivalent stress can be, for example, a von Mises equivalent stress. However, depending on the material class and load type of the object, the material class of which can be ideally tough, ductile, or ideally brittle, and the load type of which can be, for example, a static, vibrational or impact load, alternative or additional equivalent stresses can also be used.

It is advantageous in this case to simulate the same physical quantity which will later also be simulated by means of the mesh. But this is not absolutely necessary. If another spatially resolved physical quantity is simulated in the first simulation, however, this should ideally have a certain correlation with the spatially resolved physical quantity of the second simulation that the mesh uses.

The object data is used by the first simulation, at least in part, with a non-geometry-conformant mesh. In other words, the first simulation is carried out using a method that allows the use of a non-geometry-conformant mesh on at least part of the object data. To save time, a first simulation, which is based on a non-geometry-conformant mesh, can be performed on a simplified geometry of the object data, in which the small structures are first largely ignored, and/or with low accuracy requirements, e.g. in iterative methods with a smaller number of iterations. In this way, only a few local stress peaks are identified, but a rough overview of the global distribution of the stress is provided. Certain conclusions can already be drawn from this for the creation of the mesh for the second simulation.

It is preferable that the first simulation uses the object data entirely with a non-geometry-conformant mesh. The first simulation can thus be performed with relatively little computing time. In this way, the exact geometry of the object data can also be taken into account in the first simulation without prior meshing. This allows all defects and small geometries to be taken into account and local stress peaks in the object to be identified. Examples of a first simulation that do not use geometry-conformant mesh representation are the “immersed boundary method”, “extended finite element method” (XFEM), finite cell method (FCM), WEB splines, which can also be called “mesh-free methods”.

The first simulation is preferably carried out on the same object data that is to be examined in the second simulation. This refers to the object data used as the basis for the first and second simulation. Alternatively, the first simulation can be based on object data that includes a virtual nominal geometry, such as a CAD model, or another representative geometry, such as measurement data of components of the same nominal geometry. The resulting information can then be used for meshing a plurality of possibly other object data of other measured objects.

The result of the first simulation using the spatially resolved physical quantity represents a possibly coarse estimation of the results of the second simulation that has not yet been performed.

In a third step 106, using the simulated spatially resolved physical quantity of the object, from the plurality of spatially resolved structural information a subset of the plurality of spatially resolved structural information is identified that is taken into account for a mesh for simulating the object. The subset comprises the spatially resolved structural information to be taken into account.

For example, spatially resolved structural information can be considered that is arranged in regions of the object where the simulated spatially resolved physical size of the object exceeds certain thresholds. Exceeding the threshold values indicates that the stability and function of the object may be at risk. In other words, a decision is derived from the result of the first simulation as to whether small structures in the mesh to be created must be taken into account in the region under consideration. If this is not the case, the structures can be taken into account in the mesh with a coarser resolution, for example.

In a further step 108, a mesh for simulating the object is created for the second simulation of the object. The mesh in this case is created using the structural information to be taken into account. The mesh for simulating the object can be created on the object data in an optional sub-step 124. This means that the object data is also used for the second simulation.

In an alternative, optional sub-step, not shown, of step 108 the mesh for simulating the object can be created on object data other than the object data used for the first simulation.

If object data other than the object data used for the first simulation is used to create the mesh, a registration can be performed, in particular if the object data used in the first simulation and the other object data that is used to create the mesh and for the second simulation are not in the same coordinate system. This can occur, for example, if the first simulation is performed on similar, but not the same, object data as provided for the second simulation, for example, if the object data in the first simulation is provided from a CAD model.

For example, the spatially resolved structural information contained in the object data can be internal and external surfaces of the object. Internal surfaces can be interfaces between two materials. Larger surfaces are often interfaces between a material and air.

Regions in the object data that have comparatively homogenous material properties can be designated as material regions or, in short, as materials. Material regions can comprise conventional solid material or else material made of lattice structures, foam structures and fiber-composite materials. In an alternative, the material regions can be taken into account in the first and/or second simulation in a simplified form as a homogenous mass with corresponding material properties. In another alternative, the microstructures, i.e. the lattice, foam and fiber-composite structures, can be taken into account in the first and/or second simulation.

The second simulation can be performed based on the created mesh.

The results of the second simulation may differ from the results of the first simulation, so that it may turn out that some small structures should actually have been taken into account with greater accuracy in the mesh. In this case, with the result of the second simulation a warning can be output that the result of the second simulation has a certain degree of uncertainty, in particular in these regions.

Alternatively or additionally, an additional mesh can be determined on the basis of the results of the second simulation. With the additional mesh, another second simulation is performed to obtain improved results. This can be performed iteratively.

Different methods can be used to determine the spatially resolved structural information, in particular of the external surface and the defects inside the object. For example, a surface determination can be performed that identifies a transition from low to bright gray values by means of a model function. A defect detection can then be performed that searches for fluctuations in the spatially resolved structural information in homogenous material regions of the digital representation of the object.

FIG. 2 shows a schematic representation of a mesh 18 for simulating the object. Sections are shown that are represented by elements 24, in this case tetrahedra, from which the mesh 18 is formed. The edges 20 of the tetrahedra form the mesh structure illustrated. The edges 20 of the elements 24 meet at corners 22.

Also illustrated is a boundary surface 26 of the object. The boundary surface 26 shows a stronger curvature in the central area of FIG. 2 than in the left-hand area of FIG. 2. In the region of strong curvature of the boundary surface 26, the size of the tetrahedra is smaller than in the region of weak curvature of the boundary surface 26. This means that more tetrahedra are present in the region of strong curvature of the boundary surface 26 than outside this region. The largest tetrahedra are arranged far away from the boundary surface 26 in the upper area of FIG. 2. Accordingly, few tetrahedra are arranged in this region at the top of FIG. 2.

A defect 28 in the form of a pore is also arranged in the right-hand area of FIG. 2. The pore is delineated from the material by the boundary surface 30. The pore in this case is an example of spatially resolved structural information that was taken into account when creating the mesh. The elements 24 arranged around the defect 28 are also smaller than the elements 24 that are arranged far away from the boundary surfaces 26 and 30. This increases the time required to create the mesh 18, initially. However, since the first simulation only takes into account a subset of all defects in creating the mesh 18, the time required to create the mesh 18 is smaller, despite the high number of small-scale elements 24 at the boundary surface 30, than the time that would be taken if all defects in the object data were to be taken into account. Also relevant in this example can be the position of the defect 28 near the boundary surface 26, wherein this position only permits a comparatively narrow strip of material between the boundary surface 26 and the boundary surface 30. The rough shape and orientation of the defect 28 may also be relevant.

The reproduction of small structures increases the number of elements 24 in the mesh 18. However, this also applies in the area surrounding the small structures, i.e. in regions that do not directly border the boundary surfaces, since the size of neighboring elements 24 must not differ too greatly. This would negatively affect the accuracy of the simulation results.

FIG. 3 shows various optional alternative or additional sub-steps of step 106.

In an optional step 110, a local threshold value is determined for a relevance measure of a spatially resolved structural information item from the simulated spatially resolved physical quantity of the object. A spatially resolved relevance measure is calculated for the spatially resolved structural information. That is, for each position in the object, a relevance measure is calculated for the structural information at this position. A local threshold value is determined locally depending on the result of the first simulation. This means that the threshold value can vary depending on its position in the object.

According to the optional sub-step 112, only the spatially resolved structural information items that have a relevance measure above the threshold value are provided as spatially resolved structural information to be taken into account. Spatially resolved structural information, the relevance measure of which is below the threshold value, is not taken into account and therefore not provided.

In the case of defects, it can thus be decided, for example, not to take the defect into account when creating the mesh. The region that has the defect is treated like the surrounding material. Alternatively, it can also be decided to take the defect or small structures on the surface into account in the mesh. This only uses a low resolution and thus creates the mesh with elements that tend to have a larger average size.

In a further optional sub-step 114, a range of values for the spatially resolved physical quantity can be defined as an alternative or in addition. Then, in another optional sub-step 116, at least one region in the object data is identified to which the at least one spatially resolved physical quantity of the object is assigned within the range of values. That is, the physical quantity is evaluated at each position in the object to determine whether it is located within the range of values defined in step 114.

In another optional sub-step 118, the spatially resolved structural information from the at least one region is provided as defect information, which is used as spatially resolved structural information to be taken into account.

Thus, only spatially resolved structural information which includes defect information in the regions where the result of the first simulation lies within the range of values is treated as spatially resolved structural information to be taken into account in the creation of the mesh.

In another alternative or additional optional sub-step 120, an orientation of defects described by the defect information is identified with respect to a direction of the simulated loading and/or a shape of defects described by the defect information. This takes into account the shape and orientation of a defect when creating a mesh. For example, if a plate-shaped defect is oriented perpendicular to the loading direction, this is more relevant than if a cigar-shaped defect is oriented parallel to this direction. The cigar-shaped defect is less relevant and can be neglected when creating the mesh.

In a further optional sub-step 122, the defect information is then provided as spatially resolved structural information to be taken into account on the basis of the identified orientation and/or shape.

In a further optional sub-step 126, as an alternative or in addition, spatially resolved mechanical stress values are identified that are local maxima. The spatially resolved mechanical stress values that are local maxima can also be called stress peaks. These are located in particular on small structures where the material of the object can fail.

In a further sub-step 128, defect information from a predefined range of the object data that comprises the identified spatially resolved mechanical stress values is provided as spatially resolved structural information to be taken into account.

In another alternative or additional sub-step 130, the spatially resolved structural information is assigned to different materials in step 106. A material-specific rule can be used for each material to take into account spatially resolved structural information. This means that, depending on the material to which structural information is assigned at its respective position, a separate rule is used to evaluate whether spatially resolved structural information at this position is taken into account for creating the mesh. This means that information about the material arranged around the position of a spatially resolved structural information item can be taken into account in the decision. In particular, for multi-material objects that have regions of different materials, different rules can be applied for each material. For example, it is possible to take account of the fact that stresses of a certain order of magnitude that are still completely unproblematic for steel can already be problematic for plastics.

In addition, an analysis of the surrounding geometry can be performed, for example, in relation to wall thicknesses or local structures such as lattice structures, when deciding whether structural information should be taken into account at a specific position in the object.

In another alternative or additional optional sub-step 132, in step 106 at least some of the spatially resolved structural information, the defect information of which is not taken into account in step 106, can be provided to the second simulation as a material property of the object at a position of the spatially resolved structural information that is not taken into account. The spatially resolved structural information that is not taken into account when the mesh is created is not completely ignored, but is considered as a possibly averaged material property of the corresponding elements of the mesh. A pore can thus be roughly approximated by reducing the stiffness of the object in the corresponding element of the mesh as a proportion of the volume of the pore.

Further, steps 130 and 132 can be combined, wherein spatially resolved structural information that describes very small defects is completely ignored, whereas spatially resolved structural information describing medium-sized defects is only taken into account in the material properties. Only major defects are directly taken into account as spatially resolved structural information when creating the mesh.

FIG. 4 shows a schematic representation of a visualized first simulation of a physical quantity. In this case, it may be a local equivalent stress. An object 10 is shown, which has the shape of a pipe on which various isolines are entered which delineate specific regions 12, 14, 16 of different local equivalent stresses from one another.

The region 12 is arranged at an inner radius of a curve of the object 10 and has a local maximum of the stress values of the equivalent stress. The region 14 is arranged at one end of the pipe and also has a local maximum of the stress values of the equivalent stress.

Stress peaks can be observed in spatially resolved structural information that describe, for example, small notches on the surface or defects in the interior. In addition, defects in the interior can reduce the effective wall thickness at low wall thicknesses. This can lead to high or excessive stress levels. If the spatially resolved physical quantity determined by the first simulation has a local equivalent stress at a high level in one region, the geometry determined from the object data in this region is represented in the mesh with high accuracy in order to be able to estimate realistically in the second simulation the likelihood that the material in this region will fail. To decide whether increased accuracy is required, it is sufficient if a stress peak is located in a region. In this case, the geometry of the object in the environment is reproduced exactly with the mesh.

In another example, the flow of a fluid through a porous stone can also be used as the spatially resolved physical quantity. The first simulation then calculates the flow of the fluid in a spatially resolved manner. In the regions where a large material flow is observed, even a small change in the geometry of the object can lead to large changes in the material flow. The geometry in this region is accurately reproduced to provide realistic simulation results in the second simulation.

The invention is not restricted to any one of the embodiments described above but may be modified in a wide variety of ways.

All of the specified features and advantages resulting from the claims, the description and the drawing, including constructional details, spatial arrangements and method steps, can be essential to the invention either in themselves or in the most diverse of combinations.

1. A computer-implemented method for creating a mesh for simulating an object, wherein the mesh is determined by means of object data of the object, wherein a digital representation of the object is provided using the object data, wherein the digital representation of the object comprises a plurality of spatially resolved structural information relating to the object, and wherein the method comprises the following steps:
providing object data of the object;
carrying out a first simulation of at least one spatially resolved physical quantity of the object by means of the object data;
identifying spatially resolved structural information to be taken into account by means of the simulated spatially resolved physical quantity of the object for a mesh for simulating the object from the plurality of spatially resolved structural information; and
creating the mesh for simulating the object by means of the structural information to be taken into account for a second simulation of the object.

2. The method as claimed in claim 1, wherein the first simulation and/or the second simulation is a mechanical simulation of the object.

3. The method as claimed in claim 2, wherein the spatially resolved physical quantity is a local equivalent stress of the object.

4. The method as claimed in claim 1, wherein the step of identifying spatially resolved structural information to be taken into account for a mesh for simulating the object from the plurality of structural information by means of the simulated spatially resolved physical quantity of the object has the following sub-steps:
determining a local threshold value for a relevance measure of a spatially resolved structural information item from the simulated spatially resolved physical quantity of the object; and
providing at least a portion of the spatially resolved structural information of the plurality of spatially resolved structural information as spatially resolved structural information to be taken into account if a relevance measure of a spatially resolved structural information item exceeds the determined threshold.

5. The method as claimed in claim 1, wherein the spatially resolved structural information comprises defect information within the digital representation of the object.

6. The method as claimed in claim 5, wherein the defect information comprises information about pores in the digital representation of the object.

7. The method as claimed in claim 5, wherein the step of identifying spatially resolved structural information to be taken into account for a mesh for simulating the object from the plurality of structural information by means of the simulated spatially resolved physical quantity of the object comprises the following sub-steps:
defining a range of values for the spatially resolved physical quantity;
identifying at least one region in the object data to which the at least one spatially resolved physical quantity of the object is assigned within the range of values; and
providing defect information as spatially resolved structural information from the at least one region to be taken into account.

8. The method as claimed in claim 5, wherein the step of identifying spatially resolved structural information to be taken into account for a mesh for simulating the object from the plurality of spatially resolved structural information by means of the simulated spatially resolved physical quantity of the object has at least one of the following sub-steps:
identifying an orientation of defects described by the defect information with respect to a direction of a simulated load and/or a shape of defects described by the defect information; and
providing the defect information as spatially resolved structural information to be taken into account on the basis of the identified orientation and/or shape.

9. The method as claimed in claim 1, wherein the step of creating the mesh for simulating the object by means of the structural information to be taken into account for a second simulation of the object has the following sub-step:
creating the mesh for simulating the object on the object data.

10. The method as claimed in claim 1, wherein the first simulation is designed to use a non-geometry-conformant mesh on at least a portion of the object data.

11. The method as claimed in claim 1, wherein the object data comprises measurement data from a computer tomographic measurement of the object.

12. The method as claimed in claim 1, characterized in that the at least one spatially resolved physical quantity comprises spatially resolved mechanical stress values, wherein the step of identifying spatially resolved structural information to be taken into account for a mesh for simulating the object from the plurality of spatially resolved structural information using the simulated spatially resolved physical quantity of the object comprises the following sub-steps:
identifying spatially resolved mechanical stress values that are local maxima; and
providing defect information as spatially resolved structural information to be taken into account from a region of the object data that has a predefined extension around the identified spatially resolved mechanical stress values.

13. The method as claimed in claim 1, wherein the spatially resolved structural information is assigned to different materials, wherein in the step of identifying spatially resolved structural information to be taken into account for a mesh for simulating the object from the plurality of spatially resolved structural information by means of the simulated spatially resolved physical quantity of the object, a material-specific rule for taking into account spatially resolved structural information is used for each material.

14. The method as claimed in claim 1, wherein at least a portion of the spatially resolved structural information, which is not taken into account in the step of identifying the spatially resolved structural information to be taken into account for a mesh for simulating the object from the plurality of spatially resolved structural information by means of the simulated spatially resolved physical quantity of the object, is provided to the second simulation as a material property of the object at a position of the spatially resolved structural information that is not taken into account.

15. A computer program product having instructions executable on a computer, which when executed on a computer cause the computer to carry out the method as claimed in claim 1.
